(19) United States
(12) Patent Application Publication
(10) Pub. No.: US 2024/0169334 A1
(43) Pub. Date: May 23, 2024

(54) APPARATUS, SYSTEM, AND METHOD FOR A SECURITY OPERATIONS MANAGEMENT MODULE FOR A PAYMENT TERMINAL

(71) Applicant: JABIL INC., St. Petersburg, FL (US)

(72) Inventors: Toon Diels, St. Petersburg, FL (US); Gregory Mandarin, St. Petersburg, FL (US); Thomas Cantin, St. Petersburg, FL (US); Danny Peeters, St. Petersburg, FL (US); Albert Liang, St. Petersburg, FL (US); Karim Achari, St. Petersburg, FL (US); Sylvain Umdenstock, St. Petersburg, FL (US)

(21) Appl. No.: 18/512,635

(22) Filed: Nov. 17, 2023

Related U.S. Application Data
(60) Provisional application No. 63/426,668, filed on Nov. 18, 2022.

(51) Int. Cl. G06Q 20/20; G06Q 20/38

(52) U.S. Cl. CPC G06Q 20/206; G06Q 20/382

(57) ABSTRACT

Apparatuses, systems and methods of providing a security operations management (SOM) module for a payment system. Included are: a main board having primary processing components of the SOM module, and having a first security feature for impeding physical penetration of objects from to the primary processing components; a top board having at least a battery and secondary processing components of the SOM module on a presenting face to the first face for electrically connecting to the primary processing components, and having a second security feature; and an intermediate board providing a passthrough between the main and top boards to allow for the electrical connection of the primary processing components and the battery and the secondary processing components, and comprising a third security feature for impeding physical penetration into the passthrough.

### CROSS-REFERENCE TO RELATED APPLICATIONS

The disclosure claims the benefit to U.S. patent application No. 63/426,668, filed Nov. 18, 2022, the disclosure of which is hereby incorporated by reference in its entirety.

### BACKGROUND

### Field of the Disclosure

The disclosure relates to payment terminals, and, more particularly, to a security operations management module for a payment terminal.

### Description of the Background

Points of sale are typically very poorly protected against physical attacks. Consequently, these points of sale are frequently targeted for data hacks using such physical attacks.

Attackers can access sensitive data, such as credit card number and PIN codes, that are temporarily stored on and pass through the point of sale, such as to prevent data loss in the event that the payment process is interrupted. This data can be read by the attackers by gaining physical access to the secure data path, such as using probes or mini-drills.

Therefore, the need exists for additional security measures to protect the secure data path in contact and contactless payment terminals.

### SUMMARY

The disclosed exemplary apparatuses, systems and methods provide a security operations management (SOM) module for use in a payment system terminal. Included in the SOM may be a main board having primary processing components of the SOM module on a first face thereof, and having, on an opposing face to the first face, a plurality of connectors arranged in a large grid array (LGA), the LGA additionally comprising, at a central portion of the opposing face, security pads that prevent/impede physical penetration of objects from the opposing face to the first face; a top board having at least a battery and secondary processing components of the SOM module on a presenting face to the first face, wherein the battery and at least ones of the secondary processing components electrically connect to the primary processing components at least to, at times, provide power to the primary processing components, and having an outer top face including a secure cap at least partially covering the battery, the secure cap preventing/impeding physical penetration of objects from the secure cap to the presenting face; and an intermediate board between the main board and the top board, the intermediate board providing a passthrough to allow for the electrical connection of the primary processing components and the battery and the secondary processing components, and the intermediate board comprising at least an embedded security mesh for preventing/impeding physical penetration of objects through the intermediate board into the passthrough.

The primary processing components included on the main board may execute a variety of operational modes. One such mode may be a freeze-unfreeze mode. In this mode, the unfreeze operation is performed in a controlled environment, such as to restrict access to sensitive information. The freeze/unfreeze process includes the steps of: receiving a reading of a unique serial number (SN) of the SOM module; sending an authenticated command including a unique symmetric key, derived from a symmetric master key, using the unique SN; encrypting a first code using the unique symmetric key; storing the first code in a secure random access memory (RAM), and the encrypted first code in an internal flash memory; and resetting the secure RAM upon a physical disconnection of the battery to thereby deactivate the SOM module.

Once the battery is reconnected, the steps performed by the processor include: receiving a re-reading of the SN; re-sending the authenticated command including the symmetric key based on the re-reading of the SN; decrypting the encrypted first code from the internal flash memory; and restoring the decrypted encrypted first code to the secure RAM to thereby reactivate the SOM module for deployment. Of note, the SOM may use a similar process to protect the symmetric key at any point in the process in which there is secretive information to be protected. As such, the authentication command can occur at any time if the public key of the freeze/unfreeze tool is maintained in the SOM firmware.

Therefore, the disclosure provides a security operations management module for a payment terminal and/or a point of sale.

### BRIEF DESCRIPTION OF THE DRAWINGS

The disclosure provided herein describes and includes the accompanying drawings, in which like numerals may represent like elements, and wherein:

FIG. 1 illustrates an exemplary payment terminal;

FIG. 2 is a software architecture diagram;

FIG. 3 illustrates an exemplary component assembly;

FIGS. 4A-4D illustrate an exemplary board stack in the embodiments;

FIGS. 5A-5D illustrate an exemplary board stack in the embodiments; and

FIG. 6 is a flow diagram illustrating an exemplary process in the embodiments.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are well known in the art, and because they do not facilitate a better understanding of the present disclosure, a discussion of such elements and operations is not provided herein. However, the present disclosure is deemed to inherently include all such elements, variations, and modifications to the described aspects that would be known to those of ordinary skill in the art.

Description is provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that embodiments may be embodied in different forms. As such, the embodiments described are exemplary in nature, and should not be construed to limit the scope of the disclosure.

The terminology used herein is for the purpose of describing particular exemplary embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the exemplary embodiments.

Processor-implemented modules and systems are disclosed herein that may provide access to and transformation of a plurality of types of digital content, including but not limited to plans and data streams, and the algorithms applied herein may track, deliver, manipulate, transform, transceive and report the accessed content. Described embodiments of these modules, apps, systems and methods are intended to be exemplary and not limiting.

An exemplary computing processing system for use in association with the embodiments, by way of non-limiting example, is capable of executing software, such as an operating system (OS), applications/apps, user interfaces, and/or one or more other computing algorithms, such as the algorithms, decisions, models, programs and subprograms discussed herein. The operation of the exemplary processing system is controlled primarily by non-transitory computer readable instructions/code, such as instructions stored in a computer readable storage medium, such as hard disk drive (HDD), optical disk, solid state drive, Random Access Memory (RAM), a flash memory, or the like. Such instructions may be executed within the central processing unit (CPU) to cause the system to perform the disclosed operations. In many known computer servers, workstations, mobile devices, personal computers, and the like, the CPU is implemented in an integrated circuit called a processor.

It is appreciated that, although the exemplary processing system may comprise a single CPU, such description is merely illustrative, as the processing system may comprise a plurality of CPUs. As such, the disclosed system may exploit the resources of remote CPUs through a communications network or some other data communications means.

In operation, CPU fetches, decodes, and executes the instructions from the computer readable storage medium. Information, such as the computer instructions and other computer readable data, is transferred between components of the computing system via the system's main data-transfer path.

In addition, the processing system may contain a peripheral communications controller and bus, which is responsible for communicating instructions from CPU to, and/or receiving data from, peripherals as discussed herein throughout. An example of a peripheral bus is the Peripheral Component Interconnect bus that is well known in the pertinent art.

An operator display/graphical user interface (GUI) may be used to display visual output and/or presentation data generated by or at the request of processing system, such as responsive to operation of the aforementioned computing programs/applications. Such visual output may include text, graphics, animated graphics, and/or video, for example.

Further, the processing system may contain a network adapter which may be used to couple to an external communication network, which may include or provide access to the Internet, an intranet, an extranet, or the like. Communications network may provide access for processing system with means of communicating and transferring software and information electronically. Network adaptor may communicate to and from the network using any available wired or wireless technologies. Such technologies may include, by way of non-limiting example, cellular, Wi-Fi, Bluetooth, infrared, or the like.

Included in the disclosed embodiments is a SOM (Security Operations Management) module for payment components in PCI (payment card industry) payment systems, such as may include EMV (Europay, Visa, MC), Apple Pay, GooglePay, PTS (PIN transaction security), and other similar contactless payments. The disclosed SOM is preferably a hardware, firmware and software module meeting relevant PCI and DSSs (Data Security Standards).

The disclosed SOM module may be used as physically secure core module of, for example, an EFTPOS (Electronic Funds Transfer at Point of Sale), also referred to herein as a payment terminal, at a POI (Point of Interaction), such as a retail POI. Along with the SOM, the EFTPOS may embed not only contactless payment hardware, software and firmware, but additionally contact payment hardware, software and firmware, such as as keyboard for information, such as PIN entry, from a payor.

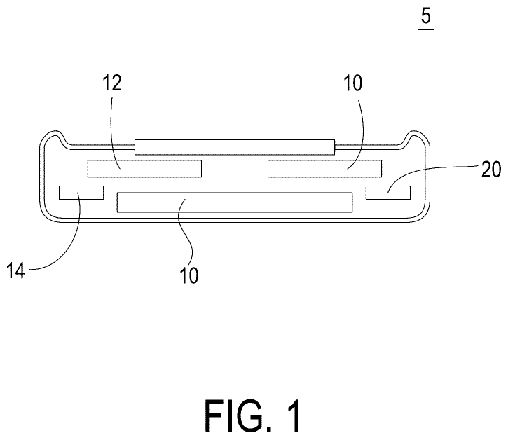

The SOM module may be particularly associated with the disclosed printed circuit board (PCB) designs as an aspect of an overall contact-contactless payment terminal and system. As such, all certifications and security for such a payment terminal system may preferably be embedded in the SOM. The disclosed SOM module/assembly may form part of a known payment terminal, such as is illustrated in the cross-sectional view of FIG. 1.

As shown, the payment terminal 5 may include contact 10 and contactless 12 reading hardware and firmware, computing features 14 and SOM module 20. The SOM may include all components of such a payment terminal that require physical security, while those elements providing logical security may also be wholly or partially embedded in the components of the SOM.

As such, the SOM module enables self-certification and/or minimal certification for adding secure EMV/payment capability to any payment system. Such systems include contact or contactless payments without pin entry, contact or contactless payments with pin entry, or any other CVM (Cardholder Verification Method).

The SOM module 20 encapsulates secure stacks for EMVCo L1/L2, PCI PTS certifications. Level 1 (contact/contactless) certification is the responsibility of the device hardware supplier, and Level 2 (contact/contactless) certification is the responsibility of the device software supplier of software within the SOM. Likewise, the disclosed SOM meets certification standards for PCI PTS, as referenced throughout.

The secure stack(s) may operate on a well known, secure microcontroller unit (MCU), also referred to herein as a processor. The software architecture may further provide support for any of a variety of known payment schemes, and may enable modification for new payment schemes as they arise.

The SOM module smoothly integrates with the requisite systems for contact and contactless payment. For example, integrated elements include: the communication interface for an external system controller; peripheral interfaces for supporting wireless communication, such as cellular, wifi, Bluetooth, BLE, etc.; resources to support L3 integration; power delivery to the SOM; and partially or fully embedded software control.

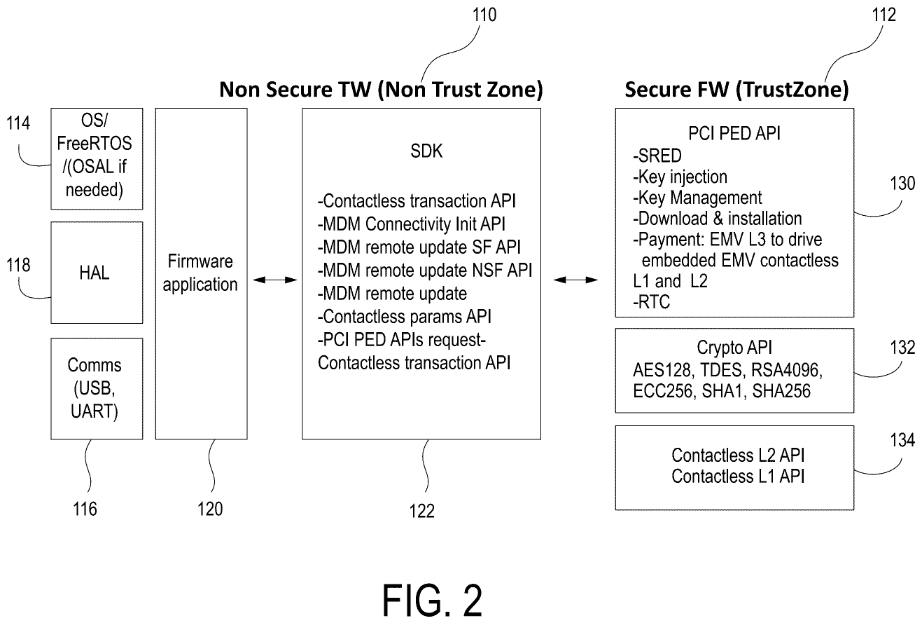

FIG. 2 illustrates a software architecture 100 for a SOM module 20 in exemplary embodiments. The architecture may execute in conjunction with NFC (Near Field Communication) per ISO 14443 A/B, such as for contactless payments per EMVCo 3.1 and EMVCo L1/L2.

The payment schemes supported by the architecture may include, but are not limited to: Visa Contactless; Mastercard Contactless; American Express Contactless (ExpressPay); Discover Contactless (D-PAS); JCB Contactless; ChinaPay; and Interac (Canada). Support is thus provided for contactless and non-contactless payments within these various schemes via PCI and PTS at the POI, such as using v6.x support (6.1 per March 2022).

Support is provided for stack customization, as well as flexible peripheral and protocol integration. This flexible integration (e.g., host control, L3 integration) is enabled by application performance developed using a SDK (Software Development Kit). The foregoing is provided in conjunction with a microcontroller-centric operating system, such as RTOS, AZURE or FreeRTOS, by way of non-limiting example.

The afore-discussed architecture may be provided as illustrated, with a non-secure/non-trust architecture zone 110, and a secure/trust architecture zone 112. The non-trust zone includes features associated with the payment terminal hardware. For example, included in the non-trust zone is the OS 114 discussed above, as well as the communication hardware/peripherals 116 and the hardware mediator (HAL) 118. Likewise in the non-trust zone is the firmware 120 associated with the payment terminal.

Additionally in the non-trust zone are those features correspondent with the SDK 122 referenced above, and more particularly for interaction between the terminal and the API. The SDK may include features for interactions with data and device management (MDM), as well as for contactless transactions, PCI operations and pin entry (PED) transaction operations, by the API.

The trust zone then includes the various APIs to execute the disclosed embodiments. More particularly, included are the APIs for PCI PED 130, Crypto 132, contactless L1/L2 payments 134, and PCI SRED.

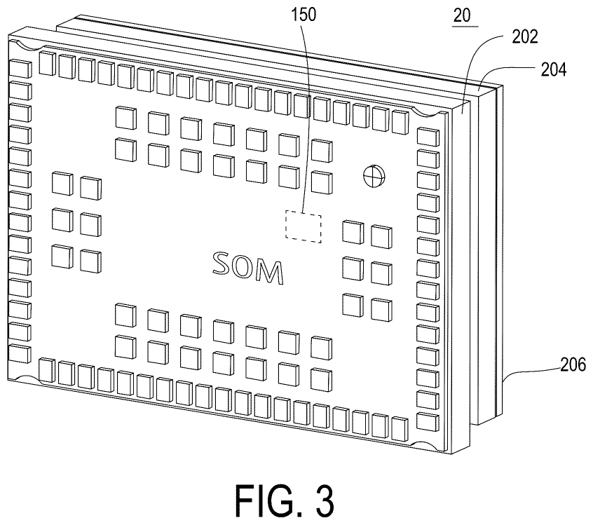

FIG. 3 illustrates an exemplary full SOM component assembly 20, which may be comprised of multiple securely protected PCBs. In the illustration, a secure controller 150 may be provided, as further discussed below. For example, a secure controller STM32U5 may be employed, such as may embed a Cortex-M33 at 160 MHz. Also provided as part of the payment terminal package may be a contactless reader, such as ST25R3917B/ST25R3916B.

The SOM may have any interface of chip to board, such as a LGA interface or a standard interface. The chip package may address tamper signals for keypad (such as using a mechanical keyboard or touch screen); may include interfaces such as for UART, USB and SPI; and may include a communication module (e.g., cellular, wifi/ble, ble), a wiremesh (the SOM may generate tamper signals that enable wiremesh outside the SOM to protect a contact smart card reader), LEDs, a buzzer, and debug signalling; a NFC reader/coil; and may be within a secure enclosure.

By way of example, the security operations management (SOM) module used in the payment system terminal may include three PCBs 202, 204, 206. The first may be a main board 202 having the primary processing components of the SOM module, such as the aforementioned secure controller 150 and storage 220 and a path 222 for secure data, as well as a contactcontactless controller, on a first face thereof. On an opposing face, the main board may have a plurality of connectors arranged in a large grid array (LGA) 230. The LGA may, in addition to connectivity, provide security 232 to impede physical penetration by an attacker to the first face.

A second, top board 204 may include and/or integrate a battery 240 and secondary processing components 242. The battery and some of the secondary processing components electrically connect to the primary processing components. The battery may also enable secure transport between manufacturing of the SOM and the integration of the SOM into a product. On a face opposite the secondary processing components, the top board may include a secure cap 244 to impede physical penetration by an attacker to the battery and the secondary processing components.

An intermediate board 206 between the main board and the top board may provide a passthrough 250 to allow for the electrical connection of the primary processing components and the battery and the secondary processing components. The intermediate board may also include security features 252, such as an embedded security mesh, for preventing/impeding physical penetration by an attacker into the passthrough.

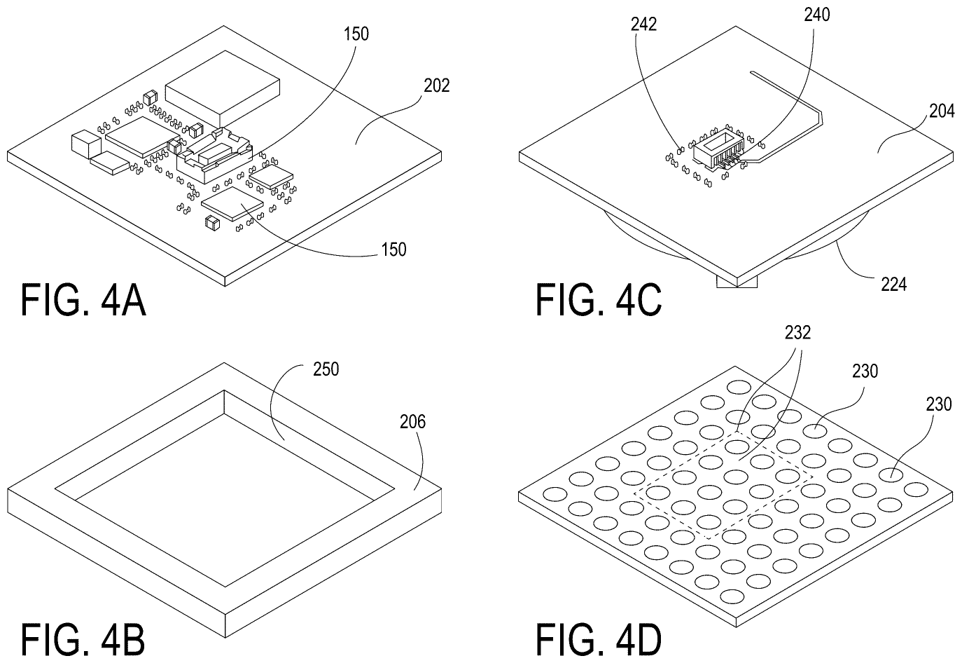

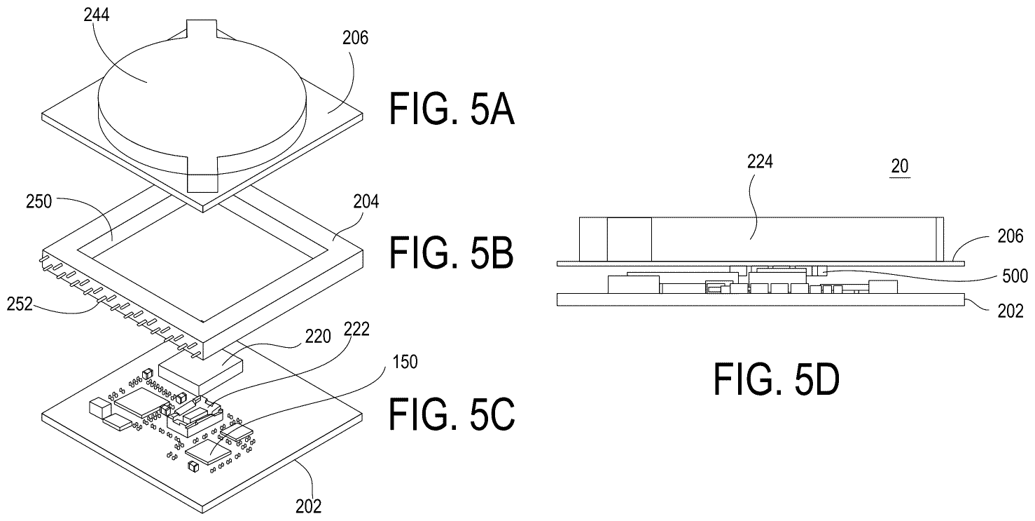

FIGS. 4A-4D and 5A-5D illustrate a specific exemplary SOM component assembly 20, which includes a physically secure enclosure of key components, of the three PCB 202, 204, 206 configuration mentioned above. The SOM module 20 may be any of a variety of sizes or shapes, and may be miniaturized, such as being about 24 mm×24 mm and about 2.5 mm in thickness by way of non-limiting example, and may be comprised of multiple PCBs or similar elements. Further, the use of, for example, a Wafer Level Chip Scale Package (WLCSP) may further enable the aforementioned miniaturization.

The multiple PCBs may include the main PCB 202, such as with a LGA 230 to allow for high density connections. The underside of the main PCB may appear as in FIG. 4D, and may include any connection pattern, such as the aforementioned LGA pattern of a connection pad assignment, in which some pads provide connectivity and some pads serve as “security pads” 232, particularly in the middle of the PCB whereat physical security attacks are most likely. As used herein, pads may include circle, rectangles, spheres or hemispheres, or the like, and may or may not be substantially uniform.

Also shown is the supportive/protective middle PCB. The middle PCB may be sized and shaped so as to allow for connectivity between components on the top and bottom PCBs in the passthrough, and so as to provide physical security to the interfaced components on the top and bottom PCBs. Therefore, between the security components on the top side of the top PCB, the bottom side of the bottom PCB, and the sides provided by the intermediate PCB, a fully secure physical enclosure is provided to protect the components of the SOM module from attack.

The SOM assembly thus may include multiple, such as three, PCBs, such as in a miniature stack assembly, providing significant physical security. That is, the components and structure of the disclosed SOM module prevent tampering or similar nefarious access to secure signals. For example, the afore-discussed two component-laden PCBs may reside on the top and bottom of the assembly, and between those two PCBs and the middle board, support and physical security may be provided by combinations of security pads, security caps, wire and other security mesh, plastic molding, and similar physical security measures that will be apparent to the skilled artisan in light of the disclosure herein.

By way of non-limiting example, the bottom PCB may include some or all components of the SOM, and physical security protection. This physical security protection may be in the form of security pads, a security cap or cover, plastic (non-conductive) molding, wire mesh, a vias-mesh, or a similar suitable substance or element capable of preventing/impeding physical security attacks from below the SOM.

As mentioned, the top PCB may include secondary components, or support for the components of the bottom PCB, specifically such as a battery, such as a coin battery, a printed battery, and/or a backup coin or printed battery. When a printed battery is provided, the battery structure may be used to prevent/impede drilling attacks, such as by comprising a protective mesh pattern.

Also part of the top PCB may be board-to-board (B2B) connector(s) 500, and security protection to prevent/impede attacks from the top of the SOM module instead of or in addition to security features of the battery itself, such as multiple layers of mesh, such as wiremesh or vias-mesh, embedded in the top PCB. As referenced, instead or also included may be a protective cover atop the SOM, and this cover may be formed of plastic or a similar difficult-to-penetrate substance. The B2B connectors may manage the top/bottom PCB removal detection discussed herein, including with respect to the freeze-unfreeze features, and wire mesh transmission and inter-component communication between the bottom PCB and the top PCB.

The third, or central/intermediate, PCB may be soldered, epoxy-ed, or otherwise attached to the bottom PCB, the top PCB, or both. This side-protecting PCB may, but doesn't necessarily, include one or more layers of wiremesh or a mesh pattern generated by vias, by way of example, to provide side-protection of the components of the top and bottom PCBs as mentioned throughout.

The SOM module may additionally include a pin and contact organization so as to avoid tampering and enhance security. For example, tamper signal pins, such as for switches and wire-meshes, for use when the SOM module is associated with a secure keyboard and/or secure contact smart card reader, may preferably be positioned in the center of a square formed of the aforementioned LGA. These pins, therefore, are exceedingly difficult to reach for a prospective attacker.

The disclosed SOM is preferably manufactured using approved/certified PCI/PTS hardware, firmware and software. Further, the battery/battery backup may be added to one of the PCBs of the SOM prior to entry of the SOM to any secure manufacturing area.

Once in the secure area, the firmware and any secure/security/encryption information, such as key loading, key signature, and/or freeze/unfreeze information as discussed herein, may be injected into the SOM. The SOM's tamper-proofing and tamper-evidencing seals (when present) may be activated for departure from the secure manufacturing area for protection of the SOM during shipment.

The customer, from a PCI/PTS point of view, receives an active SOM. At the customer, the SOM is put in a Freeze Mode, such as using a Freeze Secure Tool/Key. The battery of the SOM may be removed for soldering the SOM onto a proprietary/product/customer PCB. If the battery is printed on the top PCB, that top PCB may be removed.

The SOM may be soldered or otherwise connected to the product PCB. The battery, or the top PCB with the printed battery, may be returned to the SOM. The SOM may then be unfrozen using an Unfreeze Secure Tool/Key.

After unfreezing, the product is active again, from a PCI/PTS point of view. The product may then be shipped to a merchant, still protected by the tamper—proofing and—evidencing. Once in the field with the merchant, a Remote Key Injection may occur based on the initial secure information which was loaded. Of note, in some circumstances key injection may also be performed before shipment to a merchant.

The freezing-unfreezing process may be carried out by the primary processing components, such as may include the secure controller, discussed throughout. More particularly, the primary processing components may execute non-transitory computing code stored in an associated computing memory for providing the freeze-unfreeze modes, as well as various different operational modes.

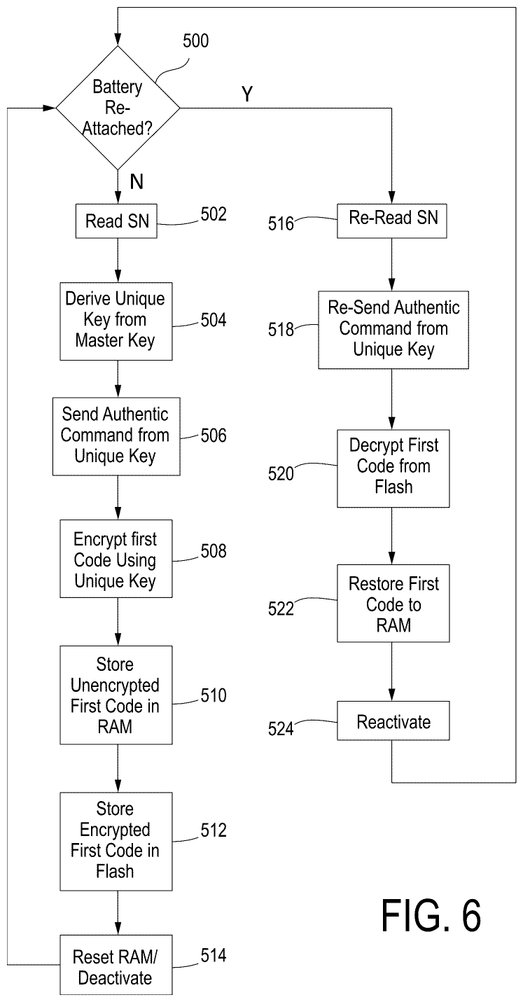

Specifically for the freeze-unfreeze process, and as illustrated with respect to the flow diagram of FIG. 6, the processor may receive a reading of a unique serial number (SN) of the SOM module; may send an authenticated command including a unique symmetric key, derived from a symmetric master key, using the unique SN; may encrypt a first code using the unique symmetric key; may store the first code in a secure random access memory (RAM), and the encrypted first code in an internal flash memory; and may reset the secure RAM upon a physical disconnection of the battery to thereby deactivate the SOM module, such as during the manufacturing process in the secure area as discussed herein.

Then, once the battery is reconnected, the processor may receive a re-reading of the SN; may re-send the authenticated command including the symmetric key based on the re-reading of the SN; may decrypt the encrypted first code from the internal flash memory; and may restore the decrypted encrypted first code to the secure RAM to thereby reactivate the SOM module for deployment.

In a more specific embodiment of the Freeze Process, the Freeze Secure Tool receives, such as by reading, a SOM's unique Serial Number (SN). The Freeze Secure Tool then sends to the SOM an authenticated command that provides a unique symmetric key, i.e., a FreezeKEY, derived from a symmetric Freeze Master Key using that SOM's unique SN. Thereby, a key pair is used.

The SOM encrypts its KPRIV (private key), which is associated with a KPUB (public key) assigned at the secure area using the FreezeKEY. Of note, the SOM may similarly encrypt any secretive information to be held. The encrypted KPRIV is stored in the SOM's internal flash memory, and the cleartext KPRIV is stored in the SOM's secure RAM. The SOM is capable of encrypting any security/encyption Keys stored in its secure RAM. Further, removal of the battery/backup battery may erase or otherwise reset the SOM's secure RAM.

In a more specific embodiment of the Unfreeze Process, the SOM battery backup is back in place. The Unfreeze Secure Tool reads the SOM's unique Serial Number and sends an authenticated command providing the unique symmetric FreezeKEY. The SOM then decrypts KPRIV from the flash memory and restores it in the secure RAM (the KPUB assigned at the secure area is still stored in flash as it was never erased). The SOM may also decrypt all other Keys, and restores them in the SOM's secure RAM. The SOM component is then active in the customer product and may be deployed.

As referenced, the SOM disclosed, when used as a contactless reader, satisfies PCI PTS certifications. Consequently, a customer that integrates the SOM as disclosed into that customer's product does not need to implement separate security features and achieve PCI PTS certification, as the customer product may simply adopt the PCI/PTS certification of the integrated SOM.

Likewise, if the customer integrates the SOM into a product that includes a secure keyboard and a secure contact smart card reader, the customer may leverage the PCI PTS security features of the SOM. This reuse of the PCI PTS certification of the SOM not only greatly simplifies the PCI/PTS certification of an payment terminal incorporating the SOM, but will also greatly reduce, such as by up to or more than halving the time for, the PCI PTS certification time of the final product.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features claimed as follows.

What is claimed is:

1. A security operations management (SOM) module for use in a payment system terminal, comprising:
a main board having primary processing components of the SOM module on a first face thereof, and having, on an opposing face to the first face, a plurality of connectors arranged in a large grid array (LGA), the LGA additionally comprising, at a central portion of the opposing face, security pads that impede physical penetration of objects from the opposing face to the first face;
a top board having at least a battery and secondary processing components of the SOM module on a presenting face to the first face, wherein the battery and at least ones of the secondary processing components electrically connect to the primary processing components at least to, at times, provide power to the primary processing components, and having an outer top face including a secure cap at least partially covering the battery, the secure cap impeding physical penetration of objects from the secure cap to the presenting face; and
an intermediate board between the main board and the top board, the intermediate board providing a passthrough to allow for the electrical connection of the primary processing components and the battery and the secondary processing components, and the intermediate board comprising at least an embedded security mesh for impeding physical penetration of objects through the intermediate board into the passthrough.

2. The module of claim 1, wherein each of the top, main and intermediate boards is 24 mm×24 mm.

3. The module of claim 1, wherein the primary processing components comprise a wafer level chip scale package.

4. The module of claim 1, wherein the primary processing components comprise a secure data path.

5. The module of claim 4, wherein the impeded physical penetration is an interface to the secure data path.

6. The module of claim 1, wherein the secure cap comprises a plastic molding.

7. The module of claim 1, wherein the secure cap comprises a security mesh.

8. The module of claim 7, wherein the security mesh comprises one of a vias-mesh and a wire mesh.

9. The module of claim 1, wherein the embedded security mesh comprises one of a vias-mesh and a wire mesh.

10. The module of claim 1, wherein the battery is a coin battery.

11. The module of claim 1, wherein the battery is a printed battery.

12. The module of claim 11, wherein the printed battery comprises a printed protective mesh.

13. The module of claim 1, wherein the intermediate board is either soldered or epoxy-ed to at least one of the top board and the main board.

14. A security operations management (SOM) module for use in a payment system, comprising:
a main board having primary processing components of the SOM module on a first face thereof, and having, on an opposing face, a first security feature for impeding physical penetration of objects from the opposing face to the first face;
a top board having at least a battery and secondary processing components of the SOM module on a presenting face to the first face for electrically connecting to the primary processing components, and having a second security feature for impeding physical penetration of objects to the presenting face;
an intermediate board providing a passthrough between the main and top boards to allow for the electrically connecting of the primary processing components and the battery and the secondary processing components, and comprising a third security feature for impeding physical penetration of objects into the passthrough;
the primary processing components executing non-transitory computing code stored in an associated computing memory for providing a plurality of operational modes, including a freeze-unfreeze mode comprising the steps of:
receiving a reading of a unique serial number (SN) of the SOM module;
sending an authenticated command including a unique symmetric key, derived from a symmetric master key, using the unique SN;
encrypting a first code using the unique symmetric key;
storing the first code in a secure random access memory (RAM), and the encrypted first code in an internal flash memory;
resetting the secure RAM upon a physical disconnection of the battery; and
once the battery is reconnected:
receiving a re-reading of the SN;
re-sending the authenticated command including the symmetric key based on the re-reading of the SN;
decrypting the encrypted first code from the internal flash memory; and
restoring the decrypted encrypted first code to the secure RAM to thereby activate the SOM module for deployment.

15. The module of claim 14, wherein each of the top, main and intermediate boards is about 24 mm×24 mm.

16. The module of claim 14, wherein the primary processing components comprise a secure data path.

17. The module of claim 16, wherein the impeded physical penetration is an interface to the secure data path.

18. The module of claim 14, wherein the embedded security mesh comprises one of a vias-mesh and a wire mesh.

19. The module of claim 14, wherein the battery is a coin battery.

20. The module of claim 14, wherein the battery is a printed battery comprising a printed protective mesh.

21. A security operations management (SOM) module for use in a payment terminal, comprising:
a main board having primary processing components for secure data on a first face thereof, and having, on an opposing face, a first security feature for impeding physical penetration of objects from the opposing face to the first face;
a top board having at least a battery on a presenting face to the first face for powering the primary processing components, and having a second security feature for impeding physical penetration of objects to the presenting face;
an intermediate board providing a passthrough between the main and top boards for electrical connection therebetween, and comprising a third security feature for impeding physical penetration of objects into the passthrough;
the primary processing components executing non-transitory computing code stored in an associated computing memory for providing a plurality of operational modes, including an unfreeze mode that follows disconnection and occurs upon reconnection of the battery, comprising the steps of:
receiving a reading of a serial number of the SOM module (SN);
sending an authenticated command including a unique symmetric key derived from a symmetric master key prior to disconnection of the battery using the unique SN;
decrypting a first code encrypted using the unique symmetric key upon disconnection of the battery from the internal flash memory; and
restoring the decrypted first code to secure RAM to thereby activate the SOM module for deployment.

22. The module of claim 21, wherein each of the top, main and intermediate boards is about 24 mm×24 mm.

23. The module of claim 21, wherein the embedded security mesh comprises one of a vias-mesh and a wire mesh.

24. The module of claim 21, wherein the battery is a coin battery.

25. The module of claim 21, wherein the battery is a printed battery comprising a printed protective mesh.

26. A security operations management (SOM) module for use in a payment terminal, comprising:
a main board having primary processing components for secure data and including security features above, below and aside the primary processing components for impeding physical penetration of objects to the secure data;
the primary processing components executing non-transitory computing code stored in an associated computing memory for providing a plurality of operational modes, including an unfreeze mode that follows disconnection and occurs upon reconnection of the battery, comprising the steps of:
receiving a reading of a serial number of the SOM module (SN);
sending an authenticated command including a unique symmetric key derived from a symmetric master key prior to disconnection of the battery using the unique SN;
decrypting a first code encrypted using the unique symmetric key upon disconnection of the battery from the internal flash memory; and
restoring the decrypted first code to secure RAM to thereby activate the SOM module for deployment.

27. The module of claim 26, wherein the security features comprise at least one of a vias-mesh, wire mesh, and a plastic cap.

28. The module of claim 26, further comprising a battery electrically connectable to the main board for occasionally powering the primary processing components, the battery comprising at least one of the security features.
